(19) United States
(12) Patent Application Publication
(10) Pub. No.: US 2009/0079706 A1
(43) Pub. Date: Mar. 26, 2009

(54) Display Device

(75) Inventors: Yasuyuki Mishima, Mobara (JP); Setsuo Kobayashi, Mobara (JP); Takayuki Higuchi, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/237,434

(22) Filed: Sep. 25, 2008

(30) Foreign Application Priority Data
Sep. 26, 2007 (JP) 2007-249283

(51) Int. Cl. G06F 3/041

(52) U.S. Cl. 345/173

(57) ABSTRACT

In a display device having a touch panel, it is possible to prevent the generation of a screen defect caused by the intrusion of air bubbles into a UV curing resin formed between a touch panel and a display panel. The touch panel is constituted of an upper transparent-electrode-attached film and a lower transparent-electrode-attached film, and an air hole is formed in the lower transparent-electrode-attached film. Due to such constitution, in adhering the touch panel and the display panel to each other in a vacuum using a UV curing resin, air in the touch panel is also discharged and hence, there is no possibility that the touch panel swells. Accordingly, it is possible to prevent warping of the lower transparent-electrode-attached film and hence, in curing the UV curing resin for adhering the touch panel and the display panel to each other, it is possible to prevent the entanglement of air into the UV curing resin. Accordingly, a touch-panel attached display device free from a screen defect attributed to air bubbles can be manufactured.

### CROSS-REFERENCE TO RELATED APPLICATIONS

The disclosure of Japanese Patent Application No. 2007-249283 filed on Sep. 26, 2007 including the specification, drawings and abstract is incorporated herein by reference in its entirety.

### BACKGROUND

1. Field of the Invention

The present invention relates to a display device, and more particularly to a display device having a touch panel.

2. Description of Related Arts

Since a liquid crystal display device can be made small and thin, the application of the liquid crystal display device has been spreading to various fields. Mobile phones, PDA (personal digital assistant) and the like are examples of these fields. As such a liquid crystal display device, there has been known a liquid crystal display device of a type which uses a touch panel as an inputting device. Although various types of touch panels are known including an electrostatic-capacitance-type touch panel, a resistance-type touch panel and the like, the resistance-type touch panel has been relatively popularly used. The resistance-type touch panel is configured such that when an upper transparent-electrode-attached film which faces a lower transparent-electrode-attached film is pushed by a human finger, an inputting pen or the like, a transparent electrode formed on the upper transparent-electrode-attached film and a transparent electrode formed on the lower transparent-electrode-attached film are brought into contact with each other thus enabling the detection of positional information.

The touch panel is mounted on a liquid crystal display panel. Here, since the touch panel is formed of two-layered structure consisting of the upper transparent-electrode-attached film and the lower transparent-electrode-attached film, it is necessary to take the reflection of light on an interface between the respective layers into consideration. That is, when the reflection of light exists on the respective interface, it is difficult for a viewer to observe an image. To cope with such a drawback, Japanese Patent Laid-open 2000-173394 (patent document 1) discloses a technique which opens a hole in a periphery of an upper transparent-electrode-attached film, and fills liquid having specific reflectance between two films through the hole for suppressing the reflection of light from the upper transparent-electrode-attached film or the lower transparent-electrode-attached film.

On the other hand, when a gap exists between the liquid crystal display panel and the touch panel, it is necessary to take the reflection of light on these layers into consideration. To suppress the reflection of light between the liquid crystal display panel and the touch panel, there has been known a technique which adheres the touch panel and the liquid crystal display panel to each other using an adhesive agent having specific reflectance.

### SUMMARY

The direct adhesion of a touch panel and a liquid crystal display panel to each other using an adhesive agent gives rise to various problems. These problems are explained hereinafter. FIG. 10 is a perspective view of a liquid crystal display device which includes a touch panel 23 having these problems of the related art. In FIG. 10, air bubbles 28 are present in a display region 71 of the liquid crystal display device thus deteriorating visibility of a display screen. Such a liquid crystal display device is treated as a defective product. The liquid crystal display device shown in FIG. 10 is formed by adhering a resistance-system touch panel 23 to the liquid crystal display panel using a UV curing resin. In adhering the touch panel 23 to the liquid crystal display panel, the air bubbles 28 are generated.

FIG. 11 is a cross-sectional view taken along a line A-A in FIG. 10. In FIG. 11, a liquid crystal display panel 24 is constituted of a liquid crystal cell, an upper polarizer 8 adhered to an upper surface of the liquid crystal cell, and a lower polarizer 7 adhered to a lower surface of the liquid crystal cell. Here, the liquid crystal cell is constituted of a TFT substrate 4 on which thin film transistors (TFTs), pixel electrodes and the like are formed, and a color filter substrate 6. A backlight 1 is mounted on a back surface of the liquid crystal display panel 24. A touch panel 23 is adhered to an upper surface of the liquid crystal display panel 24 using the UV curing resin 9.

Although the detail of the touch panel 23 is explained later, the touch panel 23 is mainly constituted of a lower transparent-electrode-attached film 11 and an upper transparent-electrode-attached film 12, and is adhered to a base substrate 10. The base substrate 10 and the liquid crystal display panel 24 are adhered to each other using the UV curing resin 9. In the UV curing resin 9 which constitutes an adhesive agent shown in FIG. 11, air bubbles 28 are present. The air bubbles 28 are observed in the display region 71 of the liquid crystal display device shown in FIG. 10 with naked eyes.

FIG. 12A to FIG. 12C are views for explaining a reason why these air bubbles 28 are present. FIG. 12A is a schematic cross-sectional view of the touch panel 23. In FIG. 12A, the base substrate 10 is omitted. In FIG. 12A, the upper transparent-electrode-attached film 12 and the lower transparent-electrode-attached film 11 are arranged to face each other by way of an insulation seal 13. On an inner surface of the lower transparent-electrode-attached film 11, dot spacers 20 for maintaining a distance between the upper transparent-electrode-attached film 12 and the lower transparent-electrode-attached film 11 are arranged. The UV curing resin 9 is applied to a lower surface of the lower transparent-electrode-attached film 11 by coating. Air is present in a space defined between the lower transparent-electrode-attached film 11 and the upper transparent-electrode-attached film 12.

As shown in FIG. 12B, the touch panel 23 having such constitution is adhered to the liquid crystal display panel 24 in the inside of a vacuum chamber 200. The touch panel is adhered to the liquid crystal display panel 24 in a vacuum atmosphere so as to prevent the UV curing resin 9 from catching air and generating air bubbles 28 therein. However, when the touch panel 23 is arranged in the vacuum chamber 200, due to the presence of air in the touch panel 23, the touch panel 23 swells as shown in FIG. 12. As a result, the lower transparent-electrode-attached film 11 is deflected as shown in FIG. 12B. When the touch panel 23 in this state is adhered to the liquid crystal display panel 24 using the UV curing resin 9, air enters a space below the deflected portion of the lower transparent-electrode-attached film 11 and hence, as shown in FIG. 12C, air bubbles 28 are present between the liquid crystal display panel 24 and the touch panel 23. In this manner, in the related art, even when the touch panel 23 and the liquid crystal display panel 24 are adhered to each other in a vacuum atmosphere for preventing the generation of the air bubbles 28, the air bubbles 28 are eventually generated.

FIG. 13 is a view for explaining another problem of the related art. The constitution of the touch panel 23 shown in FIG. 13A is substantially equal to the constitution of the touch panel 23 explained in conjunction with FIG. 12A. As shown in FIG. 13B, the touch panel 23 is adhered to the liquid crystal display panel 24 in a vacuum. In FIG. 13B, an upper polarizer 8 and a lower polarizer 7 of the liquid crystal display panel 24 are clearly depicted. The touch panel 23 swells in the vacuum chamber 200. In the same manner as the generation of the air bubbles explained in conjunction with FIG. 12, when the touch panel 23 in a swelled state is adhered to the liquid crystal display panel 24, air bubbles 28 are generated between the touch panel 23 and the liquid crystal display panel 24.

As shown in FIG. 13B, when the touch panel 23 swells in the vacuum atmosphere, for example, there maybe a case in which the upper transparent-electrode-attached film 12 is elongated thus causing plastic deformation. For example, when the vacuum atmosphere returns to the atmosphere with the upper transparent-electrode-attached film 12 in a state that the upper transparent-electrode-attached film 12 is plastically deformed, the upper transparent-electrode-attached film 12 of the touch panel 23 is depressed due to the atmosphere and hence, as shown in FIG. 13C, a distance between the upper transparent-electrode-attached film 12 and the lower transparent-electrode-attached film 11 of the touch panel 23 is decreased. In this manner, when the distance between the upper transparent-electrode-attached film 12 and the lower transparent-electrode-attached film 11 is decreased, the Newton ring is generated thus deteriorating display quantity of the liquid crystal display device.

Accordingly, it is an object of the present invention to provide following means which can overcome the above-mentioned drawbacks. A touch panel is adhered to a display panel using a UV curing resin. The reason the air bubbles are generated at the time of adhesion lies in that when the touch panel and the display panel are adhered to each other in the vacuum atmosphere, the air in the touch panel expands and hence, the lower transparent-electrode-attached film is warped in the state that the lower transparent-electrode-attached film project outwardly. That is, the lower transparent-electrode-attached film is liable to catch the air at the time of adhesion. According to the present invention, a hole is formed in the lower transparent-electrode-attached film of the touch panel and hence, when the touch panel is set in the vacuum atmosphere, the inside of the touch panel is evacuated to a vacuum level from the hole whereby warp is not generated in the lower transparent-electrode-attached film. Accordingly, it is possible to prevent the generation of the air bubbles in the UV curing resin. The specific means are as follows.

(1) According to the first aspect of the present invention, there is provided a display device which mounts a touch panel on a display panel, wherein the touch panel is constituted of an upper transparent-electrode-attached film and a lower transparent-electrode-attached film, a gap is formed between the upper transparent-electrode-attached film and the lower transparent-electrode-attached film, and an air hole is formed in the lower transparent-electrode-attached film of the touch penal.

(2) In a display device having the constitution (1), a light blocking film is formed outside a display region of the touch panel so as to cover the air hole with the light blocking film.

(3) In a display device having the constitution (1), a plurality of air holes is formed in the lower transparent-electrode-attached film.

(4) In a display device having the constitution (1), a flexible printed circuit board is mounted on a TFT substrate of the display panel, and the air hole is formed in a short side of the touch panel where a flexible printed circuit board is not mounted on the TFT substrate.

(5) In a display device having the constitution (1), the air hole is closed.

(6) In a display device having the constitution (1), the air hole is closed with a sealing tape.

(7) In a display device having the constitution (1), the air hole is closed with a resin.

(8) In a display device having the constitution (1), the display panel and the touch panel are arranged in the inside of a mold, and the air hole formed in the lower transparent-electrode-attached film of the touch panel is closed with an adhesive layer which adheres the mold and the touch panel to each other.

(9) According to the second aspect of the present invention, there is provided a display device which mounts a touch panel on a display panel, wherein the touch panel is constituted of an upper transparent-electrode-attached film and a lower transparent-electrode-attached film, a gap is formed between the upper transparent-electrode-attached film and the lower transparent-electrode-attached film, unevenness is formed on a surface of a transparent electrode formed on an inner side of the upper transparent-electrode-attached film or on a surface of a transparent electrode formed on an inner side of the lower transparent-electrode-attached film, and an air hole is formed in the lower transparent-electrode-attached film of the touch penal.

(10) In a display device having the constitution (9), the unevenness is formed on the surface of the transparent electrode formed on the inner side of the upper transparent-electrode-attached film and on the surface of the transparent electrode formed on the inner side of the lower transparent-electrode-attached film.

(11) According to the third aspect of the present invention, there is provided a display device which mounts a touch panel on a display panel, wherein the touch panel is constituted of an upper transparent-electrode-attached film and a lower transparent-electrode-attached film, a gap is formed between the upper transparent-electrode-attached film and the lower transparent-electrode-attached film, the touch panel and the display panel are adhered to each other using a UV curing resin, and an air hole is formed in the lower transparent-electrode-attached film of the touch penal.

(12) In a display device having the constitution (11), beads having refractive index different from refractive index of the UV curing resin are dispersed in the UV curing resin.

According to the present invention, the air hole is formed in the lower transparent-electrode-attached film of the touch panel which is adhered to the display panel and hence, in adhering the touch panel to the display panel in a vacuum atmosphere, there is no possibility that air in the touch panel expands so as to curve the lower transparent-electrode-attached film. Accordingly, it is possible to eliminate possibility that air is entangled in the UV curing resin when curing such resin so that bubbles are generated in the UV curing resin. Accordingly, the touch panel and the display panel can be directly adhered to each other thus preventing the reflection of light on the interface and, at the same time, decreasing a thickness of the liquid crystal display device per se.

Further, since the expansion of air in the touch panel can be eliminated, it is possible to prevent the occurrence of a phenomenon that the upper transparent-electrode-attached film swells in a projecting manner so that the upper transparent-electrode-attached film is plastically deformed whereby the formation of a gap between the upper transparent-electrode-attached film and the lower transparent-electrode-attached film becomes unstable.

### BRIEF DESCRIPTION OF THE DRAWINGS

FIG. 1 is a plan view of a liquid crystal display device of the present invention;

FIG. 2 is a cross-sectional view of a liquid crystal display device taken along a line A-A in FIG. 1;

FIG. 3A to FIG. 3C are views showing manufacturing steps of the liquid crystal display device of the embodiment 1;

FIG. 4 is a view showing an example of positions of air holes formed in a touch panel;

FIG. 5A and FIG. 5B are views showing other examples of positions of air holes formed in the touch panel;

FIG. 6 is a cross-sectional view of a liquid crystal display device of an embodiment 2;

FIG. 7 is a cross-sectional view of a liquid crystal display device of a modification of the embodiment 2;

FIG. 8 is a cross-sectional view of a liquid crystal display device of a modification of an embodiment 3;

FIG. 9 is a cross-sectional view of a liquid crystal display device of the embodiment 3;

FIG. 10 is a perspective view of a liquid crystal display device of a related art;

FIG. 11 is a cross-sectional view of the liquid crystal display device of the related art;

FIG. 12A to FIG. 12C are views showing manufacturing steps of the liquid crystal display device of the related art; and

FIG. 13A to FIG. 13C are step views showing another problem of the related art.

### DETAILED DESCRIPTION OF THE INVENTION

The present invention is explained in detail in conjunction with embodiments.

### Embodiment 1

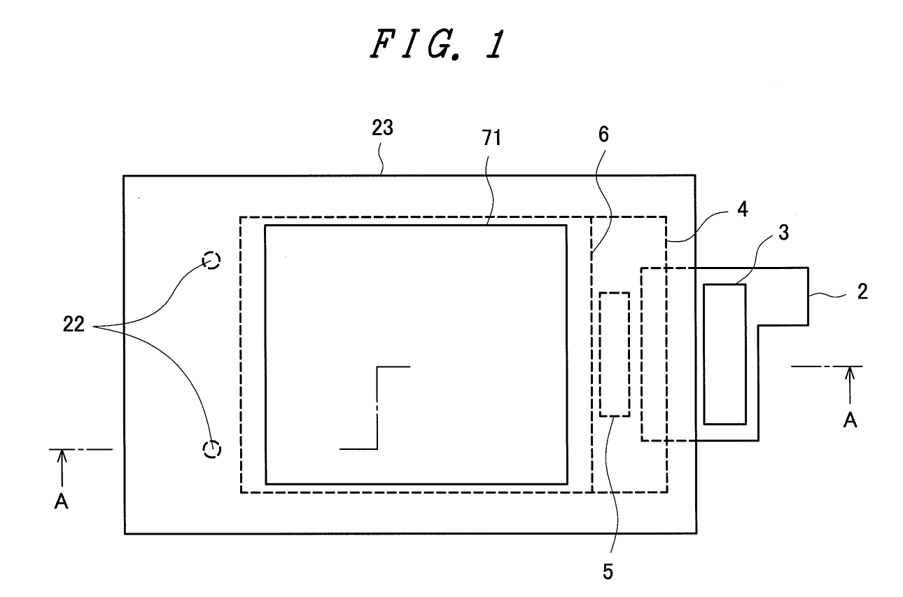

FIG. 1 is a plan view of a liquid crystal display device having a touch panel according to the present invention. In FIG. 1, a touch panel 23 is formed on a front surface of the liquid crystal display device in a visible manner. The touch panel 23 is covered with a light blocking layer 14 except for a display region 71. Air holes 22 are formed in a lower transparent-electrode-attached film 11 arranged on a back side of the touch panel 23 so as to allow the inside and the outside of the touch panel 23 to communicate with each other. The touch panel 23 is adhered to a color-filter-substrate-6 side of a liquid crystal display panel 24.

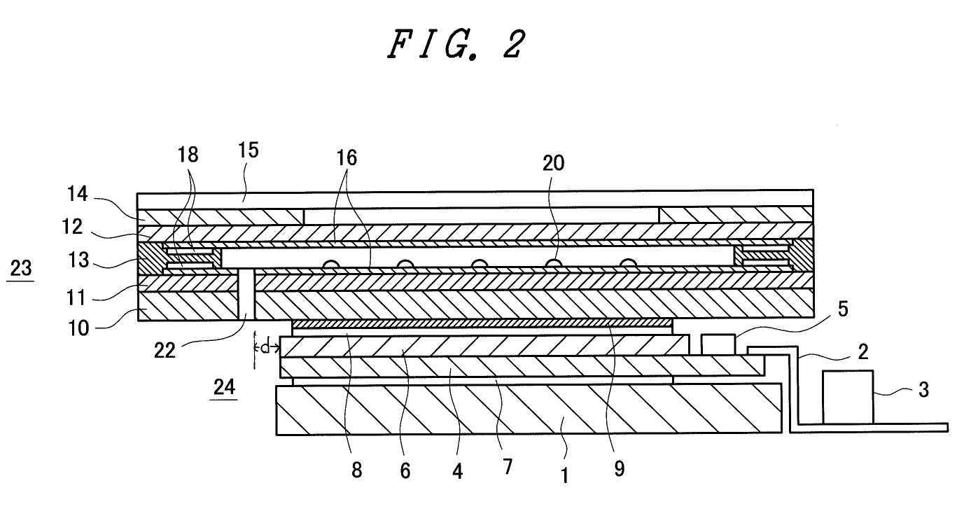

In FIG. 1, for mounting a driving IC 5, a flexible printed circuit board 2 and the like on a TFT-substrate-4 side of the liquid crystal display panel 24, the TFT substrate 4 is made larger than a color filter substrate 6. Although a flexible printed circuit board 2 is provided for connecting the liquid crystal display panel 24 and an external circuit with each other, various kinds of electronic parts 3 are also mounted on the flexible printed circuit board 2. FIG. 2 is a cross-sectional view taken along a line A-A in FIG. 1. In FIG. 2, a backlight 1 is arranged on a lowermost portion of the liquid crystal display device. The backlight 1 is constituted of a light source, various kinds of optical members, optical sheets and the like. The liquid crystal display panel 24 is arranged on the backlight 1. The liquid crystal display panel 24 is constituted of a liquid crystal cell and polarizers which are arranged on an upper side and a lower side of the liquid crystal cell. The liquid crystal cell is constituted of the TFT substrate 4 on which TFTs and pixel electrodes are arranged in a matrix array, the color filter substrate 6 on which color filters and the like are arranged, and liquid crystal not shown in the drawing which is sandwiched between the TFT substrate 4 and the color filter substrate 6.

Out of the TFT substrate 4 and the color filter substrate which constitute the liquid crystal cell, for mounting the driving IC and the flexible printed circuit board 2 on the TFT substrate 4, the TFT substrate 4 is made larger than the color filter substrate 6. The flexible printed circuit board 2 is provided for supplying signals, a power source and the like to the liquid crystal display device, and various kinds of electronic parts 3 are mounted on the flexible printed circuit board 2.

The touch panel 23 is arranged on the upper polarizer 8 of the liquid crystal display panel 24. The touch panel 23 shown in FIG. 2 includes a base substrate 10, and the lower transparent-electrode-attached film 11 is adhered to the base substrate 10. The base substrate 10 is made of polycarbonate.

The base substrate 10 is adhered to the upper polarizer 8 of the liquid crystal display panel 24 using a UV curing resin 9. The lower transparent-electrode-attached film 11 is adhered to the base substrate 10 of the touch panel 23 and an upper transparent-electrode-attached film 12 is arranged to face the lower transparent-electrode-attached film 11 in an opposed manner. The upper transparent-electrode-attached film 12 and the lower transparent-electrode-attached film 11 are respectively formed of a PET film. An ITO (Indium Tin Oxide) film 16 which forms a transparent electrode is arranged on an inner surface of the lower transparent-electrode-attached film 11 and an inner surface of the upper transparent-electrode-attached film 12. The respective electrodes formed of the ITO film 16 are connected with each other by lines 18 made of Ag. The upper transparent-electrode-attached film 12 and the lower transparent-electrode-attached film 11 have peripheries thereof sealed to each other with a specific distance therebetween using an insulation seal 13.

The touch panel 23 is configured such that when the upper transparent-electrode-attached film 12 is pushed by a human with a pen or the like, the upper transparent-electrode-attached film 12 and the lower transparent-electrode-attached film 11 are brought into contact with each other thus generating positional information. Here, to prevent the upper transparent-electrode-attached film 12 and the lower transparent-electrode-attached film 11 from maintaining an adhesion state even after these films are brought into contact with each other, dot spacers 22 made of resin are formed on an inner surface of the lower transparent-electrode-attached film 11. The light blocking layer 14 is formed on a periphery of the upper transparent-electrode-attached film 12, and a hard coating attached film 15 is arranged on the light blocking layer 14 so as to mechanically protect the upper transparent-electrode-attached film 12.

The present invention is characterized in that the air holes 22 are formed in the lower transparent-electrode-attached film 11 and the base substrate 10 for allowing the ventilation of air between the inside and the outside of the touch panel 23. By forming the air holes 22, when the touch panel 23 is set in the inside of a vacuum chamber 200, air in the touch panel 23 is also evacuated and hence, there exists no possibility that the touch panel 23 swells. Accordingly, there is no possibility that the upper transparent-electrode-attached film 12 or the lower transparent-electrode-attached film 11 is curved in a projecting manner and hence, air bubbles 28 do not intrude into the UV curing resin 9 which adheres the liquid crystal display panel 24 and the touch panel 23 to each other.

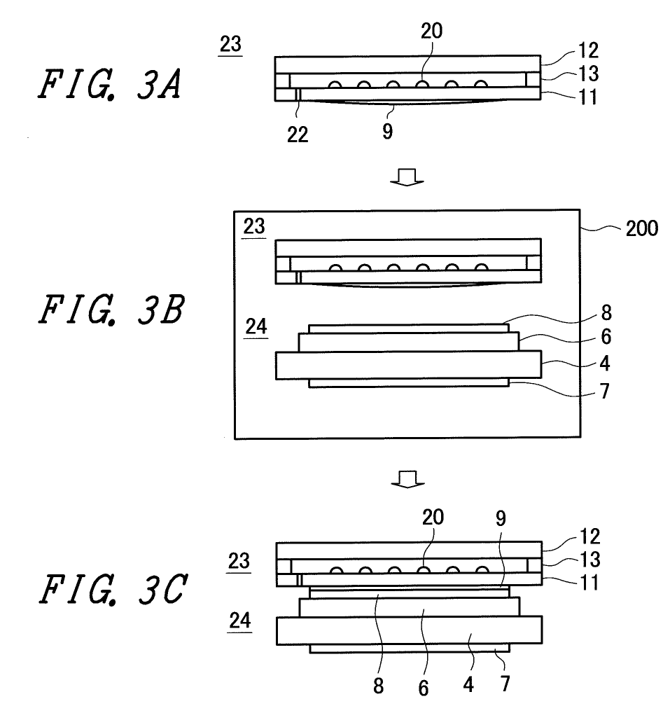

FIG. 3A to FIG. 3C show adhesion steps of the touch panel 23 and the liquid crystal display panel 24 having the constitution of the present invention. In FIG. 3, the base substrate 10 of the touch panel 23 is omitted. In FIG. 3A, the air holes 22 are formed in the lower transparent-electrode-attached film 11 of the touch panel 23. For adhering the touch panel 23 to the liquid crystal display panel 24, as shown in FIG. 3B, the touch panel 23 and the liquid crystal display panel 24 are set in the inside of the vacuum chamber 200. As also shown in the FIG. 3B, even when this touch panel 23 is set in a vacuum atmosphere in the inside of the vacuum chamber 200, due to the provision of the air holes 22, air in the touch panel 23 is also evacuated and hence, there exists no possibility that the touch panel 23 swells. Accordingly, the lower transparent-electrode-attached film 11 and the upper transparent-electrode-attached film 12 keep a flat shape. The UV curing resin 9 is applied to a lower surface of the lower transparent-electrode-attached film 11 by coating for adhering the lower transparent-electrode-attached film 11 and the upper polarizer 8 of the liquid crystal display panel 24 to each other.

In adhering the lower transparent-electrode-attached film 11 and the upper polarizer 8 of the liquid crystal display panel 24 to each other, there may be a case that a certain amount of gap (vacuum bubbles 28) exists between the lower transparent-electrode-attached film 11 and the upper polarizer 8. However, the gap (vacuum bubbles 28) is generated in a vacuum and hence, by bringing back the touch panel 23 and the liquid crystal display panel 24 which are adhered to each other into the atmosphere from the vacuum, the gap (vacuum bubbles 28) is dissipated due to the atmospheric pressure. Accordingly, as shown in FIG. 3C, it is possible to manufacture a liquid crystal display device with no air bubbles 28 between the touch panel 23 and the liquid crystal display panel 24.

The present invention is characterized in that the air holes 22 are formed in the lower transparent-electrode-attached film 11 of the touch panel 23. Due to such constitution, the air holes 22 are hardly observed from the outside with naked eyes. Further, by forming the air hole 22 in the lower transparent-electrode-attached film 11, it is possible to lower probability of intrusion of foreign materials from the outside. Further, although not shown in FIG. 2, even when the air holes 22 are closed by any suitable method, provided that the air holes 22 are formed on the back side of the touch panel 23, there exists no possibility that the material which closes the air holes 22 is observed from the outside thus deteriorating an appearance of the liquid crystal display device.

It is desirable that the number of the air holes 22 is two or more. Further, it is desirable that the respective air holes 22 are formed in a spaced-apart manner. Due to such constitution, when the touch panel 23 is arranged in the vacuum atmosphere, air in the touch panel can be smoothly discharged. Although it is unnecessary to particularly define a size of the air holes 22, by taking formability, the intrusion of foreign materials from the outside or the like into consideration, it is desirable to set the size of the air holes 22 to a value which falls within a range from φ0.5 mm to φ2 mm.

A distance from the color filter substrate 6 of the liquid crystal display panel 24 to the air hole 22, that is, a distance “d” shown in FIG. 2 from an end portion of the liquid crystal display device may preferably be set to 1 mm or more. When the air holes 22 and the color filter substrate 6 are arranged close to each other, there may be a case that the air holes 22 are closed by the UV curing resin 9 in the manufacturing steps and hence, desired advantageous effects of the present invention cannot be obtained. Further, as shown in other embodiments, there exists possibility that an operation to close the air holes 22 becomes difficult.

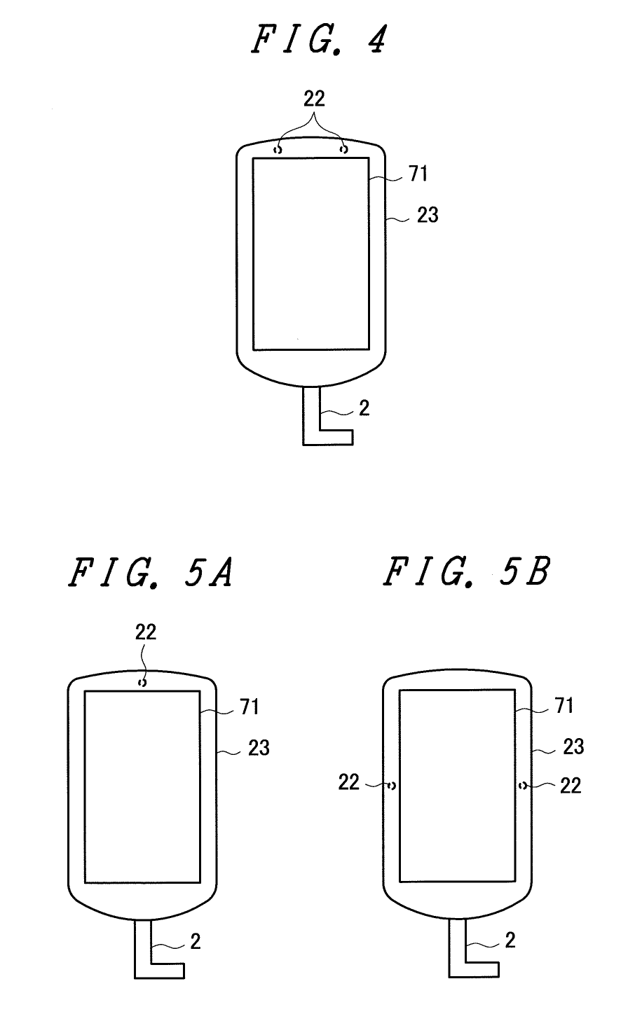

FIG. 4 shows the position of the air holes 22 in plane. According to the present invention, as shown in FIG. 4, the plurality of air holes 22 may preferably be arranged on a short side of the touch panel 23 and outside a display region 71. In FIG. 4, two air holes 22 are arranged on the short side of the touch panel 23 and outside the display region 71. On the short side of the touch panel 23, a distance between the display region 71 and an end portion of a profile of the touch panel 23 (hereinafter referred to as a picture frame) can be maximized and hence, it is possible to easily ensure a space where the air holes 22 are formed. Here, it is preferable to arrange the respective air holes 22 while setting a distance “s” as large as possible.

Further, out of these short sides of the touch panel 23, the air holes 22 may preferably be arranged on the short side where the flexible printed circuit board 2, the drive IC and the like are not arranged on the liquid crystal display panel 24. It is because, in the same manner as other embodiments, when it is necessary to close the air holes 22 or the like, mounting of the flexible printed circuit board 2 and the drive IC on the liquid crystal display panel 24 makes a panel sealing operation difficult.

FIG. 5A and FIG. 5B show other examples of arrangement of the air holes 22 according to the present invention. FIG. 5A shows the example in which, out of two air holes, one air hole 22 is arranged on the short side, and the other air hole is arranged on the long side. It is because, depending on a product, a picture frame can ensure a large width on the longitudinal side. FIG. 5B shows an example in which the air holes 22 are arranged on both long sides which face each other in an opposed manner. In this case, in a vacuum atmosphere, air in the touch panel can be smoothly discharged. Here, also in the case of FIG. 5A and FIG. 5B, the air holes 22 are formed in the lower transparent-electrode-attached film 11. Further, the air holes 22 are formed in a portion of the lower transparent-electrode-attached film 11 of the touch panel where the lower transparent-electrode-attached film 11 is covered with the light blocking layer 14.

As described above, according to this embodiment, the air holes 22 are formed in the lower transparent-electrode-attached film 11 of the touch panel 23. Accordingly, in adhering the touch panel 23 and the liquid crystal display panel 24 to each other in the vacuum atmosphere, the touch panel 23 does not swell due to air in the touch panel 23 and the lower transparent-electrode-attached film 11 is not warped and hence, it is possible to prevent the generation of the air bubbles 28 between the touch panel 23 and the liquid crystal display panel 24.

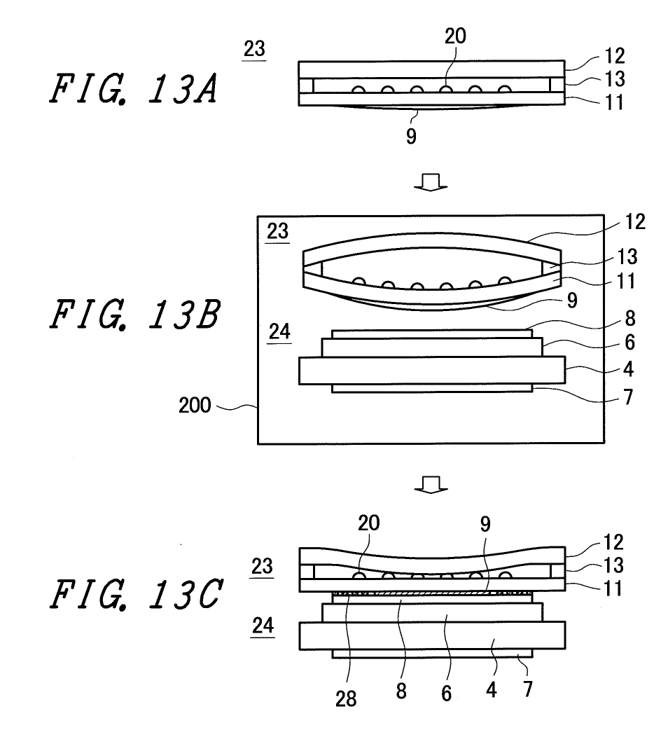

Further, in the vacuum atmosphere, the touch panel 23 does not swell and hence, there exists no possibility that the upper transparent-electrode-attached film 12 swells in a projecting manner so that the upper transparent-electrode-attached film 12 is elongated and is plastically deformed. Accordingly, it is possible to prevent a phenomenon that the upper transparent-electrode-attached film 12 is slackened so that the formation of a gap between the upper transparent-electrode-attached film 12 and the lower transparent-electrode-attached film 11 becomes unstable. That is, it is possible to overcome the drawback of the related art shown in FIG. 13.

Here, although the explanation is made in conjunction with the liquid crystal display device as the display device in this embodiment, the display device is not limited to the liquid crystal display device, and the present invention is applicable to any display device such as an organic EL display device. The same goes for the following embodiments.

### Embodiment 2

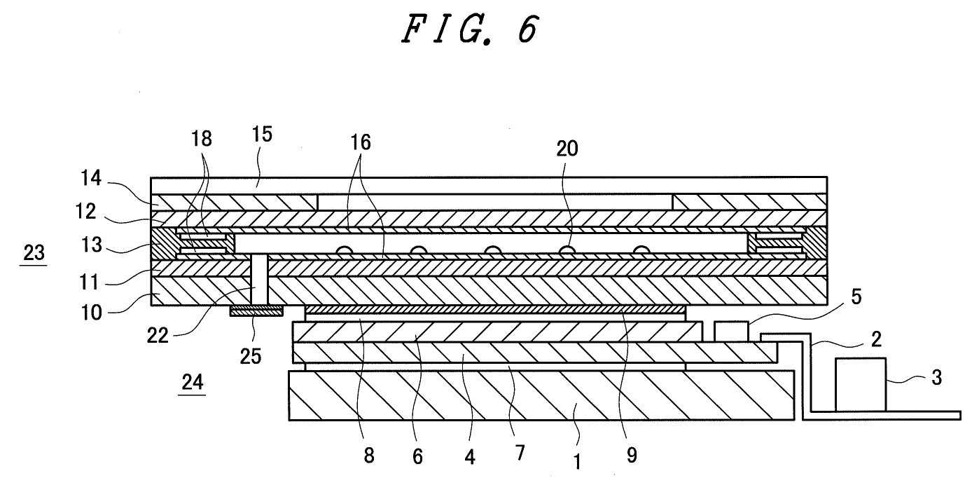

FIG. 6 is a cross-sectional view of a liquid crystal display device having a touch panel of the embodiment 2 according to the present invention. Most of the constitution of the liquid crystal display device shown in FIG. 6 is substantially equal to the constitution of the liquid crystal display device explained in the embodiment 1 in conjunction with FIG. 2. A point which makes the constitution shown in FIG. 6 different from the constitution shown in FIG. 2 lies in that air holes 22 formed in a lower transparent-electrode-attached film 11 and a base substrate 10 are closed. Although FIG. 6 shows an example in which the air holes 22 are closed by an adhesive tape 25, a material which closes the air holes is not limited to the adhesive tape 25, and the air holes 22 may be closed by a resin or the like. As such a resin, an epoxy resin, a silicon resin or the like is used.

In this manner, by closing the air holes 22, it is possible to prevent foreign materials from intruding into the inside of the touch panel from the outside. Further, by preventing moisture, a corrosion gas or the like from intruding into the inside of the touch panel from the outside, it is possible to prevent the increase of the resistance of lines 18, the ITO film 16 or the like in the inside of the touch panel. Further, by closing the air holes 22, pressure in the touch panel can be maintained and hence, it is possible to prevent a phenomenon that the upper transparent-electrode-attached film 12 of the touch panel 23 is slackened so that the formation of a gap between the upper transparent-electrode-attached film 12 and the lower transparent-electrode-attached film 11 becomes unstable.

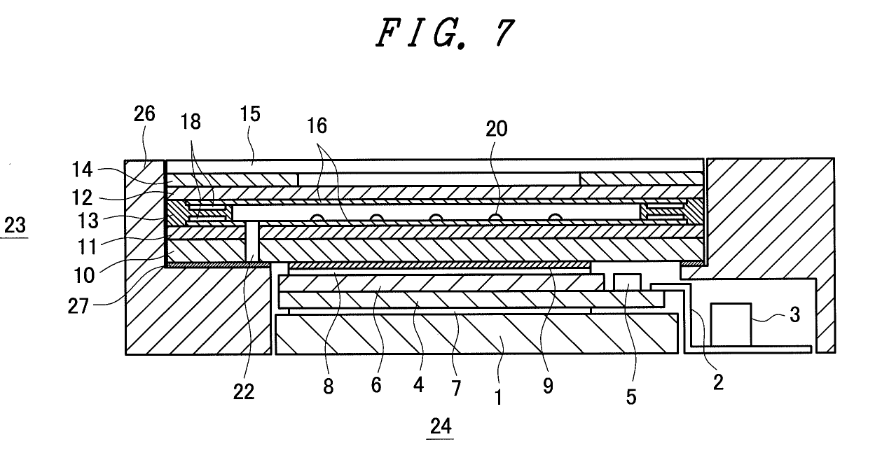

FIG. 7 is a cross-sectional view showing the liquid crystal display device of a modification of this embodiment. FIG. 7 shows an example in which the liquid crystal display device having the touch penal is arranged in a plastic mold 26. In FIG. 7, a touch panel 23 is made larger than the liquid crystal display panel 24 and hence, a lower portion of the touch panel 23 is supported on the plastic mold 26. The lower portion of the touch panel 23 and the plastic mold 26 are adhered to each other using a double-surface adhesive tape 27.

The air holes 22 are formed in the lower transparent-electrode-attached film 11 and the base substrate 10 of the touch panel 23. In FIG. 7, the double-surface adhesive tape 27 for adhering the touch panel 23 and the plastic mold 26 to each other is arranged at a portion where the air holes 22 are present, and the air holes 22 are closed by the double-surface adhesive tape 27. Accordingly, it is possible to close the air holes 22 without particularly requiring an additional step. According to also this embodiment, it is possible to prevent foreign materials, a gas, moisture or the like from intruding into the inside of the touch panel. Further, in the same manner as the embodiment 1, by closing the air holes 22, the pressure in the touch panel can be maintained and hence, it is possible to prevent a phenomenon that the upper transparent-electrode-attached film 12 of the touch panel 23 is slackened.

### Embodiment 3

In the touch panel 23, the upper transparent-electrode-attached film 12 and the lower transparent-electrode-attached film 11 are arranged to face each other in an opposed manner with a small distance therebetween. When the distance between the upper transparent-electrode-attached film 12 and the lower transparent-electrode-attached film 11 is decreased, there may be a case that a so-called Newton ring is generated with respect to a specific wavelength. The Newton ring causes lowers image quality and hence, it is necessary to prevent the generation of the Newton ring. By forming the air holes 22 in the touch panel 23, the pressure in the touch panel is lowered and hence, there may be a case that the upper transparent-electrode-attached film 12 is slackened. In this case, the distance between the upper transparent-electrode-attached film 12 and the lower transparent-electrode-attached film 11 is liable to become small. Although this slackening of the upper transparent-electrode-attached film 12 can be reduced by closing the air holes 22, it is difficult to hermetically close the air holes 22.

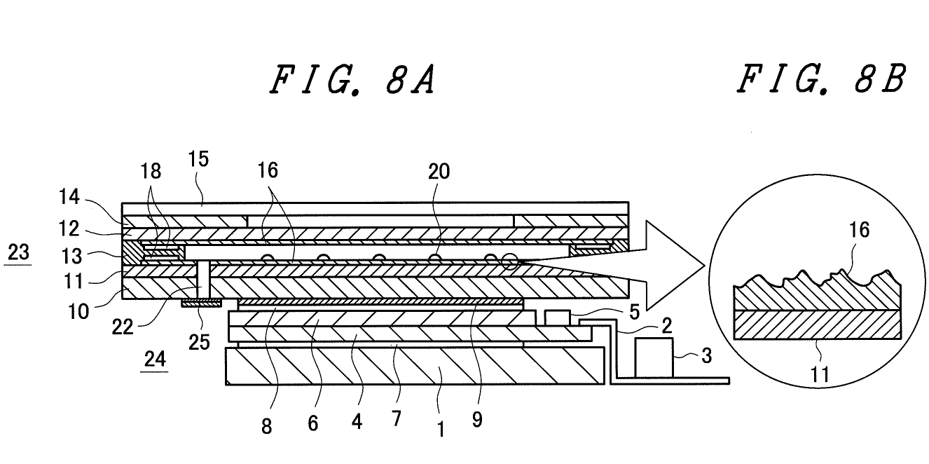

This embodiment provides the constitution of the display device which can prevent the generation of the Newton ring even when the distance between the upper transparent-electrode-attached film 12 and the lower transparent-electrode-attached film 11 is made small. FIG. 8A and FIG. 8B are cross-sectional views showing the liquid crystal display device of an embodiment 3 according to the present invention. FIG. 8A is a cross-sectional view of the whole liquid crystal display device. The constitution of the liquid crystal display device shown in FIG. 8A is substantially equal to the constitution of the liquid crystal display device shown in FIG. 6. FIG. 8B is an enlarged cross-sectional view showing the inside of the lower transparent-electrode-attached film 11 shown in FIG. 8A.

In FIG. 8B, fine unevenness is formed on an ITO electrode 16 formed on the lower transparent-electrode-attached film 11 by plasma ashing or the like. As shown in FIG. 8B, by forming the fine unevenness on a front surface of the ITO electrode 16, a distance between the ITO electrode 16 formed on the lower transparent-electrode-attached film 11 and the upper transparent-electrode-attached film 12 at a projecting portion of the ITO electrode 16 differs from such a distance at a recessed portion of the ITO electrode film 16. The Newton ring is caused by an interference fringe generated due to the interference of light having a specific wavelength with respect to a specific gap. As shown in FIG. 8B, when the unevenness is formed on the surface of the ITO electrode 16, the distance between the upper transparent-electrode-attached film 12 and the lower transparent-electrode-attached film 11 is not specified. Accordingly, even when the light having the specific wavelength is incident on the lower transparent-electrode-attached film 11, the Newton ring is hardly generated.

The ITO electrode 16 is also formed on the upper transparent-electrode-attached film 12 and hence, even when unevenness is formed on the ITO electrode 16 formed on the upper transparent-electrode-attached film 12, the substantially equal advantageous effect can be acquired. Further, it is needless to say that when unevenness is formed on both of the ITO electrode 16 formed on the upper transparent-electrode-attached film 12 and the ITO electrode 16 formed on the lower transparent-electrode-attached film 11, advantageous effects can be further enhanced.

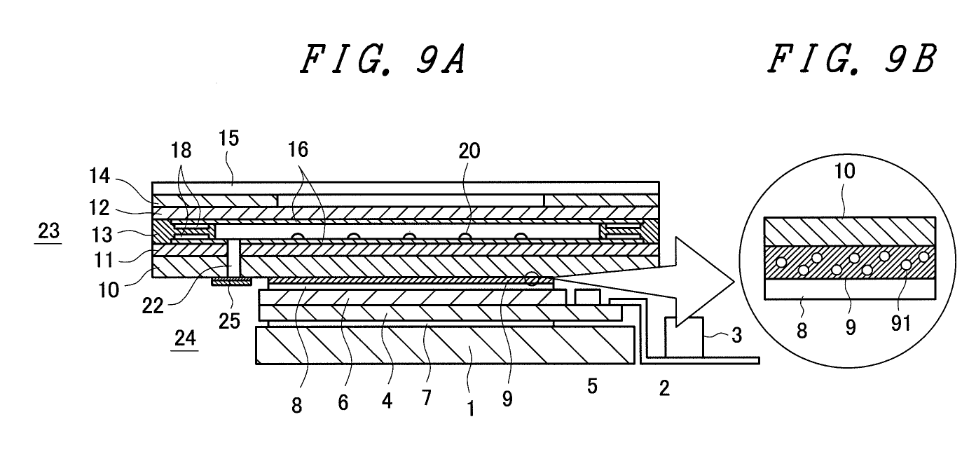

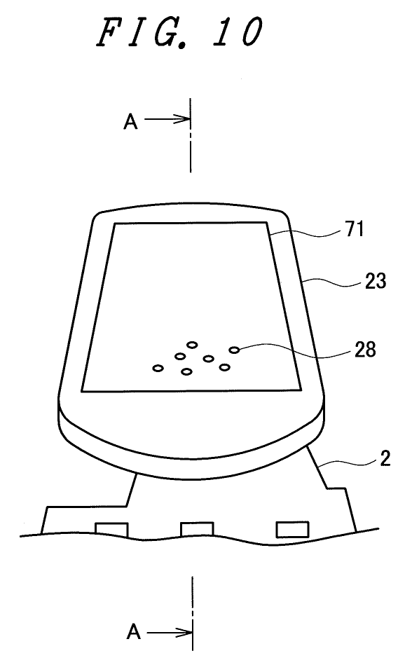

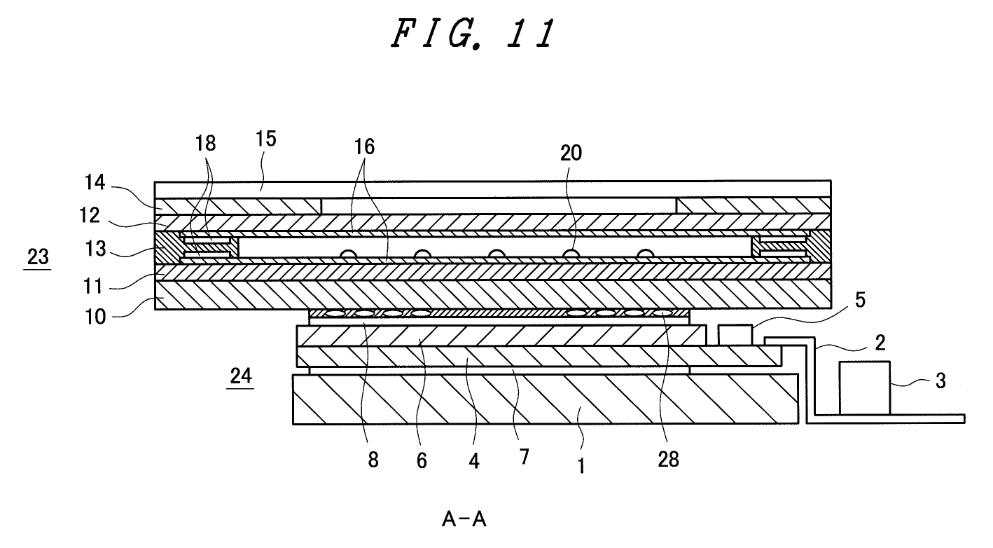

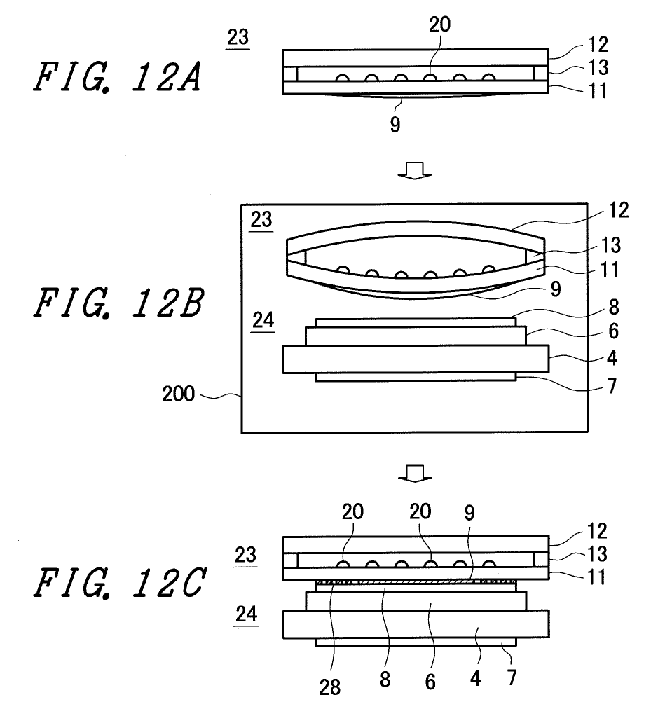

FIG. 9A and FIG. 9B are cross-sectional views showing the liquid crystal display device of a modification of this embodiment. This embodiment is also provided for preventing the generation of the Newton ring when the air holes 22 are formed in the touch panel 23. FIG. 9A is a cross-sectional view of the whole liquid crystal display device. The constitution of the liquid crystal display device shown in FIG. 9A is substantially equal to the constitution of the liquid crystal display device shown in FIG. 6. FIG. 9B is an enlarged cross-sectional view of the UV curing resin 9 after curing arranged between the base substrate 10 and the upper polarizer 8 of the liquid crystal display panel 24 shown in FIG. 9A.

In FIG. 9B, beads 91 having a refractive index different from a refractive index of a UV curing resin 9 are dispersed in the inside of the UV curing resin 9. The beads 91 may be formed of plastic beads 91. Due to the dispersion of beads having the refractive index different from the refractive index of the UV curing resin 9 in the UV curing resin 9, when light radiated from a backlight 1 passes through the UV curing resin 9, the light is scattered in various directions. Here, the Newton ring formed due to the interference of light between the upper transparent-electrode-attached film 12 and the lower transparent-electrode-attached film 11 of the touch panel 23 is the interference fringe generated due to the interference of light having a specific wavelength with respect to a specific gap. To generate the Newton ring, the light having the specific wavelength is required to advance in the specific direction. As in the case of this embodiment, when the light radiated from the backlight 1 is scattered in the various directions, the interference fringe is hardly generated and hence, the Newton ring is hardly generated.

In the above-mentioned embodiments, the explanation has been made by taking the example in which the touch panel 23 includes the base substrate 10 and a base film is adhered to the liquid crystal display panel 24, and the example in which the touch panel 23 does not include the base film and the lower transparent-electrode-attached film 11 is directly adhered to the liquid crystal display panel 24 in mixture. However, whether or not the touch panel 23 includes the base film is not essential in the present invention. The base film is made of polycarbonate or the like thus exhibiting sufficient elasticity. Accordingly, also in the case that the touch panel includes the base film, in the same manner as the case that only the lower transparent-electrode-attached film 11 is provided, when no air hole 22 is formed in the touch panel 23, the touch panel 23 swells due to air in the touch panel in the vacuum atmosphere so that the base film is curved in the projecting manner.

As has been explained heretofore, according to the embodiments of the present invention, by forming the air holes in the lower transparent-electrode-attached film 11 of the touch panel 23, the air bubbles 28 are hardly generated between the touch panel 23 and the liquid crystal display panel 24 and, at the same time, it is possible to prevent the generation of the Newton ring attributed to the presence of the air holes 22.

What is claimed is:

1. A display device which mounts a touch panel on a display panel, wherein
the touch panel is constituted of an upper transparent-electrode-attached film and a lower transparent-electrode-attached film,
a gap is formed between the upper transparent-electrode-attached film and the lower transparent-electrode-attached film, and
an air hole is formed in the lower transparent-electrode-attached film of the touch penal.

2. A display device according to claim 1, wherein a light blocking film is formed outside a display region of the touch panel so as to cover the air hole with the light blocking film.

3. A display device according to claim 1, wherein a plurality of air holes is formed in the lower transparent-electrode-attached film.

4. A display device according to claim 1, wherein a flexible printed circuit board is mounted on a TFT substrate of the display panel, and the air hole is formed in a short side of the touch panel where a flexible printed circuit board is not mounted on the TFT substrate.

5. A display device according to claim 1, wherein the air hole is closed.

6. A display device according to claim 1, wherein the air hole is closed with a sealing tape.

7. A display device according to claim 1, wherein the air hole is closed with a resin.

8. A display device according to claim 1, wherein the display panel and the touch panel are arranged in the inside of a mold, and the air hole formed in the lower transparent-electrode-attached film of the touch panel is closed with an adhesive layer which adheres the mold and the touch panel to each other.

9. A display device which mounts a touch panel on a display panel, wherein
the touch panel is constituted of an upper transparent-electrode-attached film and a lower transparent-electrode-attached film,
a gap is formed between the upper transparent-electrode-attached film and the lower transparent-electrode-attached film,
unevenness is formed on a surface of a transparent electrode formed on an inner side of the upper transparent-electrode-attached film or on a surface of a transparent electrode formed on an inner side of the lower transparent-electrode-attached film, and
an air hole is formed in the lower transparent-electrode-attached film of the touch penal.

10. A display device according to claim 9, wherein the unevenness is formed on the surface of the transparent electrode formed on the inner side of the upper transparent-electrode-attached film and on the surface of the transparent electrode formed on the inner side of the lower transparent-electrode-attached film.

11. A display device which mounts a touch panel on a display panel, wherein
the touch panel is constituted of an upper transparent-electrode-attached film and a lower transparent-electrode-attached film,
a gap is formed between the upper transparent-electrode-attached film and the lower transparent-electrode-attached film,
the touch panel and the display panel are adhered to each other using an UV curing resin, and
an air hole is formed in the lower transparent-electrode-attached film of the touch penal.

12. A display device according to claim 11, wherein beads having refractive index different from refractive index of the UV curing resin are dispersed in the UV curing resin.
